(19) United States
(12) Patent Application Publication
(10) Pub. No.: US 2024/0204853 A1
(43) Pub. Date: Jun. 20, 2024

(54) Method and Apparatus for Beam Forming

(71) Applicant: Blue Danube Systems, Inc., New Providence, NJ (US)

(72) Inventors: Chris Tsun Kit Ng, Wood Ridge, NJ (US); Seyedamirhossein Hosseini, Jersey City, NJ (US)

(73) Assignee: Blue Danube Systems, Inc., New Providence, NJ (US)

(21) Appl. No.: 18/288,085

(22) PCT Filed: Apr. 26, 2022
(86) PCT No.: PCT/US2022/026256

§ 371 Date: Oct. 24, 2023

Related U.S. Application Data
(60) Provisional application No. 63/179,668, filed on Apr. 26, 2021.

(51) Int. Cl. H04B 7/06; H04B 10/077; H04L 47/62

(52) U.S. Cl. CPC H04B 7/06952; H04B 7/0617; H04B 10/0775; H04L 47/6225

(57) ABSTRACT

Beamforming antennas are used in cellular network to improve performance by enhancing signal strength or reducing interference for given users. The beam forming patterns are cyclic in nature; for example, the beams used on Monday's between 8 and 9 am have similarities to the beams of the previous Monday in the same time period. At least one method of testing and identifying the most appropriate beam for a given antenna at a given time from a list of promising beam candidates is provided. While the cellular network is providing services to its users, the network is simultaneously testing each of the promising beam candidates and extracting data. The extracted data is used to determine the best beams out of the list of beam candidates selected for use during a particular time period.

### CROSS-REFERENCE TO RELATED APPLICATIONS

The present application is a national phase under 35 USC 371 of International Application No. PCT/US2022/026256, filed Apr. 26, 2022, which claims priority to U.S. Provisional Application No. 63/179,668, entitled “Beam Optimization Method” filed on Apr. 26, 2021, the contents of all of which are hereby incorporated by reference in their entireties.

### BACKGROUND OF THE INVENTION

When beamforming antennas are used in cellular network to improve performance (e.g., enhance signal strength or reduce interference for given users), a problem emerges as to how to identify the most appropriate beam for a given antenna at a given time.

### BRIEF SUMMARY OF THE INVENTION

In general, the best beam may depend on the wireless propagation environment, the location of the users, and the transmit/receive activity levels of the users at the given time. Many of these parameters are not fully known and are treated as predicted quantities with statistical characterization in nature. For example, wireless propagation depends on the exact location and reflection properties of all scatterers, which is virtually impossible to acquire perfect knowledge thereof. Similarly, the exact locations and activities of the users for the next beamforming moment is necessarily predictive in nature.

Disclosed herein is a closed-loop beamforming control based on interaction with live network performance and location data. Such real-time beamforming adaptation can be leveraged to improve capacity, coverage, and network reliability to form the foundation for future fully autonomous Radio Access Network (RAN)-wide orchestration. The closed-loop beamforming control based on interaction with live network performance and location data occurs simultaneously while the network is ‘live’ allowing one user to communicate with another user.

At least one embodiment of a methodology for identifying the best beams for improving wireless performance is described. Specifically, an embodiment utilizing a two-stage methodology is presented. In the first stage, a list of promising beam candidates is identified based on historical long-term environment and user information. In the second stage, a statistical performance testing framework is used to narrow this list down to the best beams out of the beam candidates based on a statistical analysis of performance data gathered by cycling through a set of beam set candidates.

Another embodiment is a method of operating a phased array communication system for communicating with a plurality of user equipment (UEs), said method comprising the steps of: defining a first set of communication beams and a second set of communication beams, wherein said first set of communications beams includes one or more differently directed and/or shaped first beams and said second set of communications beams includes one or more differently directed and/or shaped second beams that are different from said first beams; executing a cycle of operation multiple times, said cycle of operation involving a first phase followed by a second phase, wherein said first phase involves activating said first set of communication beams for a first period of time; and while activating said first set of communication beams, obtaining a plurality of performance measurements for each communication beam of said first set of communication beams, and wherein said second phase involves activating said second set of communication beams for a second period of time; and while activating said second set of communication beams, obtaining a plurality of performance measurements for each communication beam of said second set of communication beams; executing said cycle of operation multiple times, performing a statistical analysis of said performance measurements obtained for said beams of said first and second set of communication beams; identifying which said set of communication beams yields a best communications performance; and using said set of communication beams with said best communications performance to communicate with said UEs. The method further comprising the steps of: maintaining a communication link with said plurality of UEs during all said cycles of operation. The method of wherein historical long-term data is used to select said first set and said second set of communications beams, said historical long-term data is comprised of weekly and daily patterns of user distribution and activity levels. The method wherein said best beam pattern is selected from said sets of beam candidates by using: a tournament pairwise comparison to advance said best beam pattern; a round-robin manner to identify said best beam pattern; or an analysis of variance to identify said best beam pattern out of three or more sets of communication beams. The method of wherein said performance measurements comprises one or more performance data, said performance data is comprised of channel quality, volume (amount of data traffic), number of users, spectral efficiency, session count, resource block utilization, throughput, receive power, and signal quality. The method wherein said first period of time and said second period of time are equal in duration. The method wherein said first period of time and said second period of time have different durations. The method further comprising the steps of: controlling said beams in terms of an interface, said phased array communication system featuring an open interface according to the Open Radio Access Network (O-RAN) Management Plane (M-Plane) beamforming specifications.

Another embodiment is a method of operating a phased array in a communication system, at a given location, to communicate with a plurality of mobile stations, said method of comprising the steps of: selecting a time slot of a day-of-week and of a time-of-day; partitioning said time slot in a plurality of sub-time slots; selecting, for said given location, a set of beam candidates based on a historical long-term data and user information stored in data storage for each said plurality of sub-time slots within said time slot; cycling through said sub-time slots with its corresponding said set of beam candidates formed by said phased array, wherein each set of sub-time slots is repeated a plurality of times, each repeat forming a single cycle of operation; acquiring and storing received performance data of each sub-time transmitting said set of beam candidates during each of its corresponding sub-time slots of said plurality of sub-time slots repeated said plurality of times; statistically testing said received performance data to find, for each said plurality of sub-time slots, a best beam pattern out of said set of beam pattern candidates, said selecting based on said received performance data said best beam pattern that yields a best communications performance; and using said best beam pattern for each said plurality of sub-time slots to communicate with said mobile stations. The method further comprising the steps of: configuring said phased array to produce said best beam pattern. The method further comprising the steps of: maintaining a communication link with said plurality of UE during all said cycles of operation. The method wherein time to complete all cycle of operations ranges between a period of an hour to a fraction of a minute. The method wherein said time slot uses historical long-term data to select said set of beam candidates, said historical long-term data is comprised of weekly and daily patterns of user distribution and activity levels. The method wherein said best beam pattern is selected from said sets of beam candidates by using: a tournament pairwise comparison to advance said best beam pattern; a round-robin manner to identify said best beam pattern; or an analysis of variance to identify said best beam pattern out of three or more sets of communication beams. The method wherein said testing utilizes a t-test to select one of two sets of communication beams.

Another embodiment is a beamforming active antenna radio unit, within a communication system, in a given location, to communicate with a plurality of mobile stations, comprising: a plurality of antenna elements configured to support a plurality of transmit and receive beams to said plurality of mobile stations; a list of beam candidates is identified based on information comprising previous time periods at a same day-of-week and a same time-of-day; each beam candidate is based on said list of beam candidates and said plurality of antenna elements are configured using data from each said beam candidate; said plurality of antenna elements are configured to each of said beam candidate within said list of beam candidates at least once during a first cycle of operation, wherein performance data for two or more cycles are gathered; a statistical performance testing framework using said performance data to narrow said list of beam candidates down to said best beams out of said list of beam candidates; and said best beams selected to communicate to said mobile stations added to said list of beam candidates within a data storage stored under same said day-of-week and same said time-of-day. The apparatus wherein said information further comprises historical long-term environment, said location, historical user data, and historical network data. The apparatus wherein each said beam candidate comprises a beam steering angle, its beam width, any required tapering, a transmission power of a main lobe, and a proper placement of nulls. The apparatus wherein said best beam pattern is selected from said sets of beam candidates by using: a tournament pairwise comparison to advance said best beam pattern; a round-robin manner to identify said best beam pattern; or an analysis of variance to identify said best beam pattern out of three or more sets of communication beams. The apparatus wherein duration of said cycle varies from a fraction of a minute to a period of an hour.

Another embodiment is a method of operating a phased array communication system for communicating with a plurality of mobile stations (UEs), said method of comprising: defining a first set of communication beams and a second set of communication beams, wherein the first set of communications beams includes one or more differently directed and/or shaped first beams and the second set of communications beams includes one or more differently directed and/or shaped second beams that are different from the first beams; executing a cycle of operation multiple times, said cycle of operation involving a first phase followed by a second phase, wherein the first phase involves activating the first set of communication beams for a first period of time; and while activating the first set of communication beams, obtaining a plurality of performance measurements for each communication beam of the first set of communication beams, and wherein the second phase involves activating the second set of communication beams for a second period of time; and while activating the second set of communication beams, obtaining a plurality of performance measurements for each communication beam of the second set of communication beams; after executing the cycle of operation multiple times, performing a statistical analysis of the performance measurements obtained for the beams of the first and second set of communication beams to identify which set of beams yields a best communications performance; and using the identified set of beams to communicate with the UEs.

### DESCRIPTION OF THE DRAWINGS

FIG. 1A and FIG. 1B illustrate two candidate sets of beams—Beam Set A in FIG. 1A and Beam Set B in FIG. 1B according to one embodiment of the disclosure.

FIG. 2A and FIG. 2B show alternating beams patterns for collecting comparative performance measurements according to one embodiment of the disclosure.

FIG. 3A and FIG. 3B show an embodiment of the beam optimization process based on network data feedback according to another embodiment of the disclosure.

FIG. 4 presents sets of measurements corresponding to alternating beam patterns on different time slots utilizing one of the embodiments of the disclosure.

FIG. 5 shows network and mobile user data for closed-loop beamforming according to yet another embodiment of the disclosure.

FIG. 6 shows spectral improvements from directing Radio Frequency (RF) beams to focus on traffic hotspots according to another embodiment of the disclosure.

### DETAILED DESCRIPTION OF THE INVENTION

### Beamforming Candidates

Even though wireless environment, user locations, and user activities at a given time are not known exactly in advance, their possible realizations can often be characterized based on historical long-term data. For example, wireless propagation can be based on historical drive-test or field measurement data. Similarly, user distribution and activity levels often exhibit strong weekly patterns, and their realization may be predicted based on extrapolating from historical trends. For example, user distribution and activity in a given region on a Monday morning may be predicted based on collected data from previous time periods at the same day-of-week and time-of-day.

A compilation of this collected data provides weekly historical long-term data and user information. Such data and information provides periodic behavior for one or more given hours, fractions of hours, or for minutes of a given day. In other words, the data and information collected at a base station of a given Monday morning between 8 am and 9 am at a given vicinity has similar characteristics to the same data and information collected on a weekly basis the Monday before or at any Monday earlier. Other cyclic patterns also exist. The data and information collected on weekdays (Monday through Friday) at a given time also have similarities, while the data and information collected on weekends (Saturday and Sunday) have differences from those collected on weekdays in several ways.

Once these historical long-term data are collected, the optimized beams for the given realization may be found. This can be done by using the beam optimization method described in S. Shahsavari, S. A. Hosseini, C. Ng, E. Erkip, “Adaptive Hybrid Beamforming with Massive Phased Arrays in Macro-Cellular Networks,” IEEE 5G World Forum, 2018, the disclosure of which is incorporated herein by reference in its entirety. The historical data is predictive but not definitive, so different variations and combinations of such historical data may be used to generate a spectrum of possible realizations for the time of interest. Then, for each realization in this spectrum of possibilities, the beam optimization method is used to generate a correspondingly optimized beam with respect to the given realization of environment and user conditions. Each of the above optimized beams is collected to form multiple sets of promising beam candidates for the beam testing process in Stage 2.

### Statistical Beam Testing

The objective of Stage 2 is to identify the best set of beams out of the collection of candidate beam sets for a given time subject to the inherent uncertainty of the wireless environment and user distribution and activity levels. A statistical testing framework is employed to identify the best beam set for a given time period. For ease of exposition, the following explanation focuses on identifying the better set of beams out of two candidate sets of beams, i.e., beam set A and beam set B. The method involves acquiring measurements of a performance metric for the beams in each candidate set of beams.

Since there are unaccounted-for fluctuations in the factors affecting beamforming performance (e.g., wireless propagation, user distribution, and user activity levels), the set of measurements associated with each set of beams will also exhibit fluctuations. To deal with this, measurements are performed multiple times over a limited period for each candidate set of beams thereby producing two sets of measurements, one for beam set A and the other for beam set B. Then, a statistical t-test is applied to the two sets of measurements which takes into account the relationship between the statistical means and variations between the two sets of measurements. A t-test is a type of inferential statistic used to determine if there is a significant difference between the means of two groups. In general, calculating a t-test requires three key data values, e.g. the difference between the mean values from each data set (called the mean difference), the standard deviation of each group, and the number of data values of each group. It's a well know test the details of which can be found in commonly available sources.

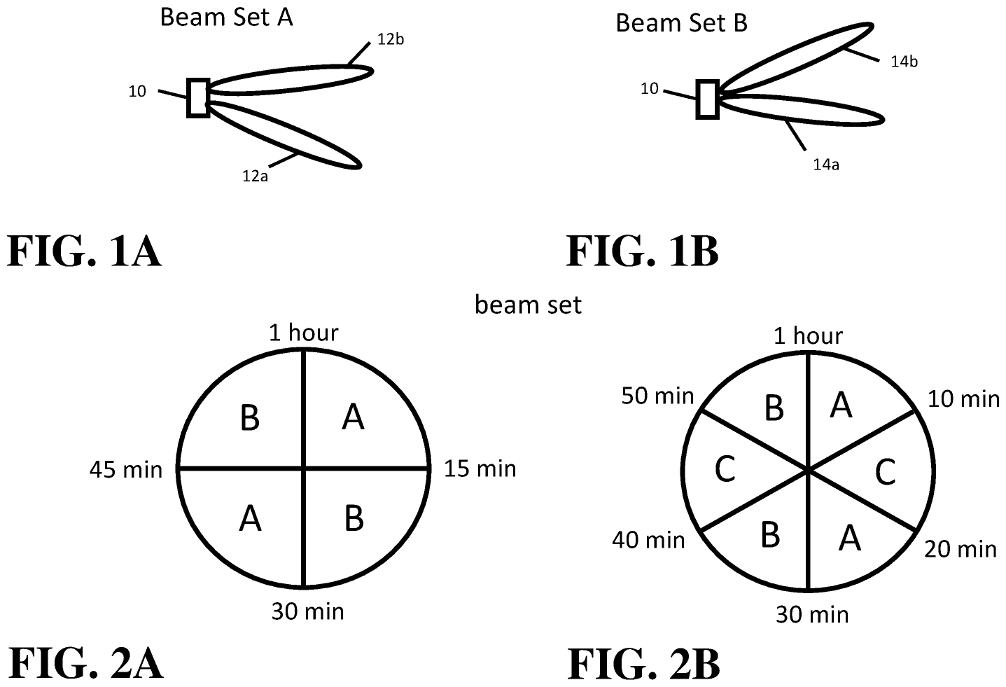

FIG. 1A and FIG. 1B, which will be used to illustrate this process, show a phased array active antenna system 10 which is capable of simultaneously generating two directed narrow communication beams 12a and 12b (although more than two beams can be used). In one embodiment, illustrated in FIG. 1A, the phased array is generating beam set A consisting of two beams 12a and 12b and in FIG. 1B, the phased array is generating beam set B consisting of two other beams 14a and 14b that are different from the beams of beam set A in direction, shape, power distribution or any combination. The two beam sets are candidate beam sets which were identified based on historical data or information used during the above-described Stage 1 of operation and represent beams sets that have historically been shown to provide optimal coverage under similar circumstances, e.g. time of year, time of day, population of users, etc.

In further embodiments, each of the drawn beams (12a, 12b, 14a, 14b) in FIG. 1 may be further comprised of two sub-beams, each of these sub-beams are orthogonally polarized to each another. For example, the first sub-beam can be vertically polarized while the second is horizontally polarized. Furthermore, the two sub-beams can be rotated around their common axis while maintaining orthogonally between the two said sub-beams. The orthogonally (90°) between the sub-beams prevents communication signals in a first sub-beam from interfering with the communication signals of the other sub-beam allowing the bandwidth of the overall communication signal to substantially double in bandwidth.

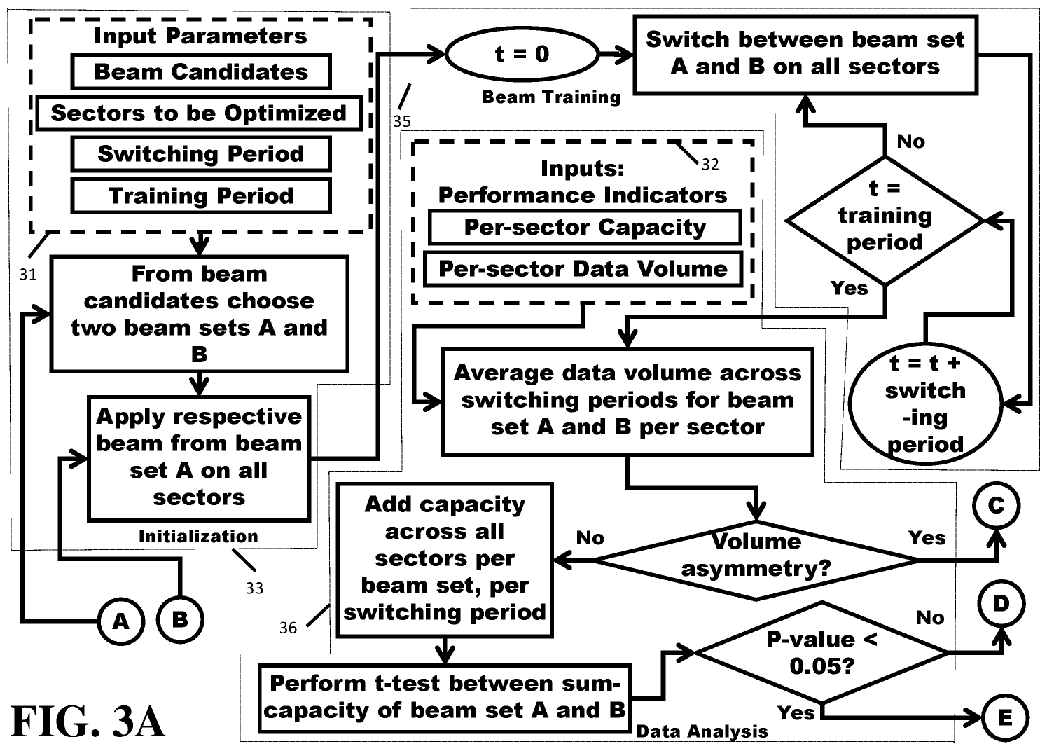

To determine which of the two sets is the optimum beam set for the current period of time, Stage 2 of operation is executed during which data on each set and each beam in that set is acquired. More specifically, referring to the example depicted in FIG. 1, first the beams 12a and 12b of beam set A are activated and used to communicate with the mobile stations or user equipment (UEs) in the serviced sector(s) while measurements of a specific performance metric, e.g. session count, are obtained and stored. In this example, as shown in FIG. 2A, the beams of beam set A are activated for a duration equal to 15 minutes. Then, during the next 15-minute period the beams of beam set B are activated and used to communicate with the UEs while measurements of the specific performance metric are obtained and stored. In the described embodiment, this sequence is repeated at least one more time. That is, beam set A is activated, and data is acquired, followed again by the activation of beam set B and the acquisition of more performance data. In short, during this phase there are alternating activations of the beam sets in a cellular network and corresponding acquisition of performance data. In the described embodiment depicted in FIG. 2A, during a one-hour time period, beam set A and beam set B are activated in an interleaving manner on a given time slot basis (15-minute, minute, or fraction of a minute time slots). This sequence is repeated until the desired number of measurements are obtained. The measurement data are then further processed using the statistical analysis framework described above (e.g. t-test).

The t-test compares the averages (or statistical means) between two samples, while taking into account the standard deviations of the two samples. For example, an average of the measurements of the performance metric is computed for each set, aggregating the measurements for all beams of that set. To be statistically significant, it is desirable that the statistical mean of one sample is greater than that of the other one relative to the standard deviations. If the t-test concludes with confidence that one set of measurements is better than the other set, then the corresponding set of beams is taken as the better set of beams of the two candidate sets. And that set of beams is used during the subsequent period to communicate with the UEs in the serviced area.

In other embodiments, the multiple directed narrow communication beams may be comprised of three or more beams candidates, as illustrated by the following embodiment.

In one embodiment, when the number of beam set candidates is greater than two, a repeated two-beam comparison may be used, or the testing framework may be generalized to compare multiple beam sets at once. A simple extension would involve applying the comparison pairwise like in a tournament, e.g., a comparison of A, B, C, D would have A vs B, C vs D, then a final comparison between the respective winners. Alternatively, in another embodiment, when the number of beam candidates is greater than two, they can be activated in a round-robin manner: e.g. with three beam set candidates, activate on beam set A during the first time slot, then activate beam set B during the second time slot, activate beam set C during the third time slot, then return to beam set. A beam on the fourth time slot, and so on. In a further embodiment, the statistical testing on the metric of interest may be performed using a statistical test that accepts multiple inputs, e.g. the Analysis of Variance (ANOVA) method over the multiple sets of measurements. ANOVA is similar to, but more general than, the t-test method above where the comparison is among multiple (i.e., greater than 2) candidates. The statistical tests require multiple test, i.e., three or more measurements. Operationally, in the active antenna field trials, typically 4 to 8 measurements were used.

Actually, there is a tradeoff between using more measurements (the more the better) and having timely measurements (e.g. measurements relevant for a specific time period of interest such as Monday 9 am-10 am). For example, if all measurements from 9 am to 9 pm are used (i.e., for a twelve-hour period), that will produce more measurements, but it will also mix up measurements from different time periods so one cannot target and optimize the beams specifically for 9 am-10 am.

Operationally in the field trials, typically measurements collected in a time period of duration 1 hour-2 hours were used. However, what is an optimal period depends on the environment and how quickly it changes.

As illustrated in FIG. 2A, the above described embodiment put on the interleaving beam patterns in a “simple” way, e.g., beam set A for 15 mins, then beam set B for the next 15 mins, then beam set A for the next 15 mins and so on (i.e., A, B, A, B, . . . ). But one could also put on the beam set candidates in any other arbitrary order, e.g., (B, A, A, B, . . . ). The order may even be randomized: i.e., at each time period, randomly choose to put on either beam set A or beam set B. The key is, over some time duration (e.g., 1-2 hours), collecting sufficient measurements under beam set A and under beam set B, so the beams may be scheduled in any arbitrary order.

Typically, one would want the period between beam switching to be as small as possible, so the conditions are similar for the different beam set candidates. Ideally, that period would be 15 minutes (or even better, 5 minutes). The limitation is that the networking equipment may only support data collection at certain time intervals (typically hourly, every 15 minutes, every 5 minutes, minutes, or fractions of a minute (seconds). Data capturing uses up valuable computation resources; one of the goals in one embodiment is to capture as much data as possible, while not substantiality degrading the characteristics of the communication channel used by the user. On the other hand, under the circumstances the longest useful period might be one hour. If the beam switching period is longer than one hour, the concern is that the environment (e.g., user locations) would have changed too much after an hour has passed and the value of the collected data would be diminished or nonrepresentative.

FIG. 2B illustrates another embodiment of interleaving multiple beam patterns in a “simple” random way, e.g., beam set A for 10 mins, then beam set C for the next 10 mins, then beam set A for the next 10 mins, then beam set B for the next 10 mins, and so on (i.e., A, C, A, B, . . . ) in a cyclic period. In other embodiments, the time interval may be further reduced towards a minute, and even lower. The data storage capacity to hold all the captured data, over a full cyclic period, increases as the time interval decreases.

It should be further noted that, in some embodiments, the periods of beam set activation need not be constant, they may vary throughout the data gathering phase.

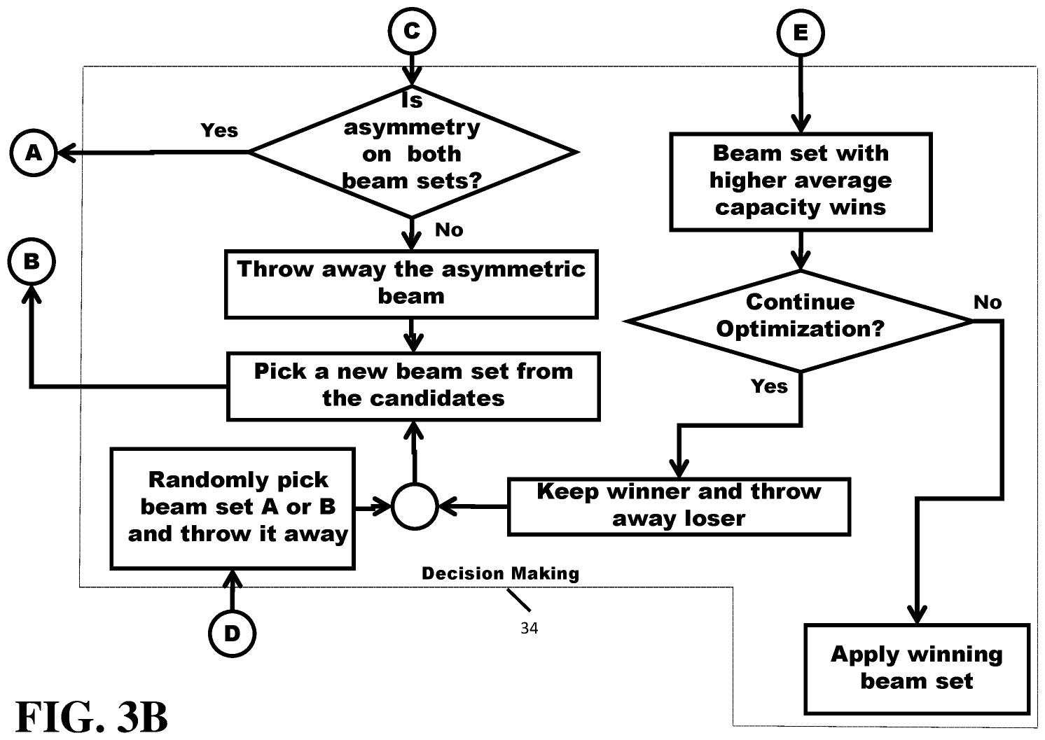

A more complete diagram of steps used to implement the method described above is shown in FIG. 3A and FIG. 3B.

The process in FIG. 3A requires inputs (shown within the dashed boxes). Several of the Input Parameters 31 are shown: Beam Candidates, Sectors to be Optimized, Switching Period, and Training Period. Additionally, inputs from another category (Performance Indicators 32) are required, for example, Per-sector Capacity and Per-sector Data Volume.

In the Initialization block 33, fed by the inputs of 31 and Node A provided by the output of Decision Making block 34 (in FIG. 3B) chooses two Beam Sets A and B. The Initialization step continues as Beam Set A is applied on all sectors with input Node B provided by the output of Decision Making block 34 indicating that a new Beam Set may be picked from the list of candidates. Once the Beam Set has been selected, the process flows to the Beam Training block 35, and initializes a timer to 0.

At timer=0, a switch to either Beam Set A or B on all sectors, whereby the timer waits till the Switching Period has been satisfied (t=t+Switching Period), then an assessment is determined if t=Training Period. If not, then switch to the other Beam Set, collect data, and wait till the Switching Period expires. If t=Training Period, then the Training Period is over, and flow to the step “Average data volume across switching periods for beam set A and B per sector” to determine the average data volume.

Though the above description involved simple averages, it can be generalized to cover volume weighted averages or other aggregation methods (e.g., ratio of sums).

If the average data volume has asymmetry (Volume asymmetry more than 1:10 between the sub-sectors on any of the sites?), then move to Node C. A decision block checks to see if there “Is asymmetry on both beam sets? Is not, “Throw away the asymmetric beam” and “Pick a new beam set from the candidates”, then move to Node B. Then, “Apply respective beam from beam set A on all sectors.” However, if there “Is asymmetry on both beam sets?” then move to Node A and “From beam candidates choose two beam sets A and B”, then continue the process flow as before.

Otherwise, if the average data volume has NO asymmetry, then “Add capacity across all sectors per beam set, per switching period” and then “Perform t-test between sum-capacity of beam set A and B.” Next, determine if the statement is false “P-value <0.05?” The P-value is an output parameter of t-test. If so, move to Node D. At this point, “Randomly pick beam set A or B and throw it away” then “Pick a new beam set from the candidates” and continue as before.

However, if the statement is true “P-value <0.05?” then move to Node E. From the Beam Set, select the one with the higher average capacity. If Optimization is stopped, then “Apply winning beam set.” If the Optimization is continued, then “Keep winner and throw away loser,” and “Pick a new beam set from the candidates,” and continue as before.

The following metrics could be used for the performance data: channel quality, volume (the amount of data traffic), number of users, spectral efficiency, session count, resource block utilization, throughput, receive power, signal quality. The measurements for these metrics are recorded by the networking equipment (e.g., the baseband processor at the cellular base station) and they are collected and time-stamped by the wireless operator. These previous metrics may be the most useful ones. Some other metrics that are sometimes used include: rank indicator (RI), channel quality index (CQI), reference signal receive power (RSRP), reference signal received quality (RSRQ), timing advance (TA), modulation and coding scheme (MCS).

Also, note that in the above-described embodiment, since it is sets of beams that are being compared and not the individual beams, the number of beams in beam set A need not be the same as the number of beams in beam set B. For example, when comparing the configuration of single sector versus two sectors, beam set A might have a single beam while beam set B may have two or more beams.

Another embodiment comprises that a filter might be employed to eliminate results that have other undesirable characteristics. For example, one beam set might prove to have better performance according to the t-test but the volume (or number of users) that is supported might be insufficient, in which case volume (or number of users) could be used as a filter to reject any outcome that does not meet some minimum requirement or threshold.

Furthermore, it should be understood that same day-of-week/time-of-day or other similar groupings may be aggregated to form the measurement time period. For example, all measurements for beam set A from multiple Monday 9 am-10 am may be considered to belong to the same set of measurements (e.g. if the network operator believes the multiple Monday morning hours all experience similar wireless propagation and user conditions).

### Live Cellular Network Case Studies

Based on the statistical beam testing and selection techniques described above, results are presented where the RF beams are optimized based on near-real-time network and user data feedback in a Massive Multiple-Input Multiple-Output (MIMO) deployment. Two beamforming active antenna radio units (RUs) were deployed on the Advanced Wireless Service (AWS) Frequency Division Duplex (FDD) frequency band in the downtown area of a city, where they are located adjacent to each other to form a cluster to allow the study of beamforming techniques for inter-cell interference management. The beamforming active antenna had a form factor of 72″×14″, similar to a traditional passive antenna. It supported 4 transmit (TX) beams and 4 receive (RX) beams, where each beam (TX and/or RX) could be independently controlled with a total TX power of 160 W. There were 96 antenna elements (4 columns×12 rows×2 polarizations) in the active antenna, where the phase and magnitude settings of each antenna element could be individually and digitally controlled for each beam. Through setting these phase and magnitude settings, the control beam steering angle (in both the elevation and azimuth directions), beam widths (e.g., wide or narrow beam), tapering (which affects the slide lobe levels), transmission power of the beam's main lobe as well as where the nulls (i.e., notches between the lobes of the beam) were placed can be controlled. In terms of the interface for controlling the beams, the active antenna RU (radio unit) featured an open interface according to the Open Radio Access Network (O-RAN) Management Plane (M-Plane) beamforming specifications, with a service-oriented architecture that accepted Extensible Markup Language (XML)-based requests for beam configuration. In particular, the elevation and azimuth beam tilt angles could be specified through the M-Plane beamforming messages, and more advanced beam shape control could be accomplished via the M-Plane custom beam configurations. The M-Plane configures, monitors, manages, and distributes services to a part of the network sub-systems.

The term “live” as used in “live network performance and location data” and “live cellular network case studies” as mentioned above implies that the testing of the network occurs while the networks are in active use carrying user data and traffic. That is, the RUs are carrying user traffic simultaneously while the operation of the network is being tested. The active antenna RU performs real-time beamforming of the full list of promising beam candidates over a number of cycles. Data for each of said promising beam candidates is collected and is used in Stage 2 to determine a best beam out of said list of promising candidates.

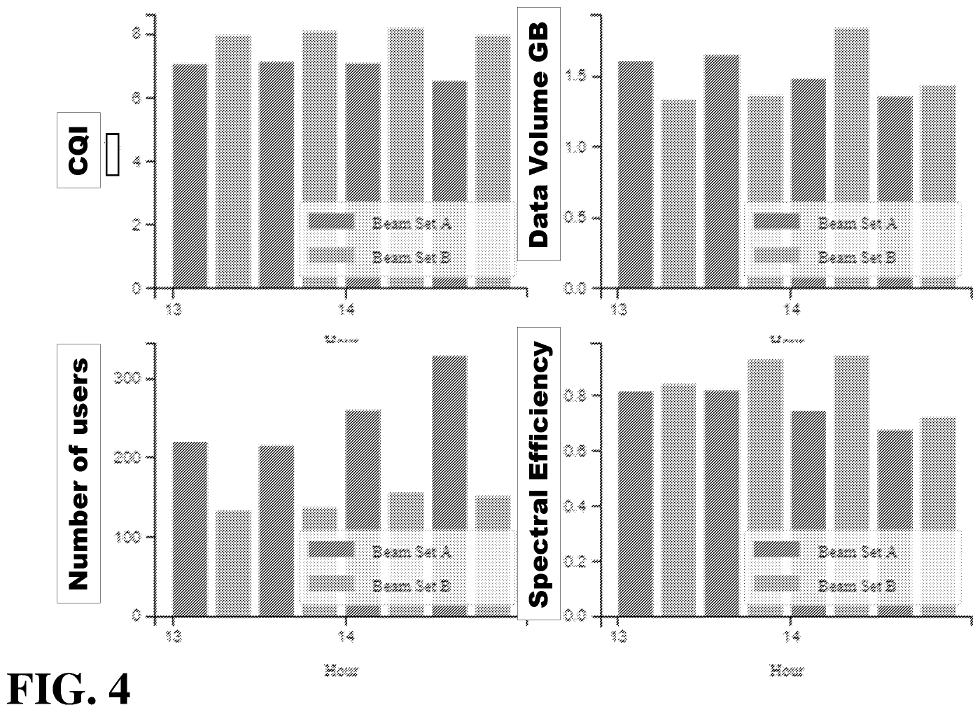

A sample of the network and mobile user data is shown in FIG. 4 which compares results for a wide beam from a passive antenna to results for an optimized beam that is one of the beams obtained through the beam optimization procedure described above. A collection of network data (e.g., session count, aggregate volume, resource block utilization) and user data (e.g., receive power, signal quality, throughput) is available to be used as inputs for the closed-loop beam optimization algorithm. The network and user data were further localized to angular bins, where the metrics were filtered with only contributing users within the small area in the angular bin. Thus, effectively, the beamforming optimization algorithm was able to use as inputs the location-specific metrics in the cellular network (up to the resolution of the angular bins).

FIG. 4 presents the Channel Quality Indicator (CQI) (the upper left chart) that rates the communication channel quality. The darker boxes correspond to Beam Set A and have less CQI then Beam Set B (lighter boxes) over this two hour period presenting 8 different measurements. The Number of Users chart is illustrated in the lower left chart. The histogram shows that Beam Set A is servicing many more users than that of Beam Set B over the same two hour period. The Data Volume (in GB) for the same two hour period is presented in the histogram in the upper right. Finally, the Spectral Efficiency for both Beam Set A and B can be compared over the same two hour period in the histogram in the lower right.

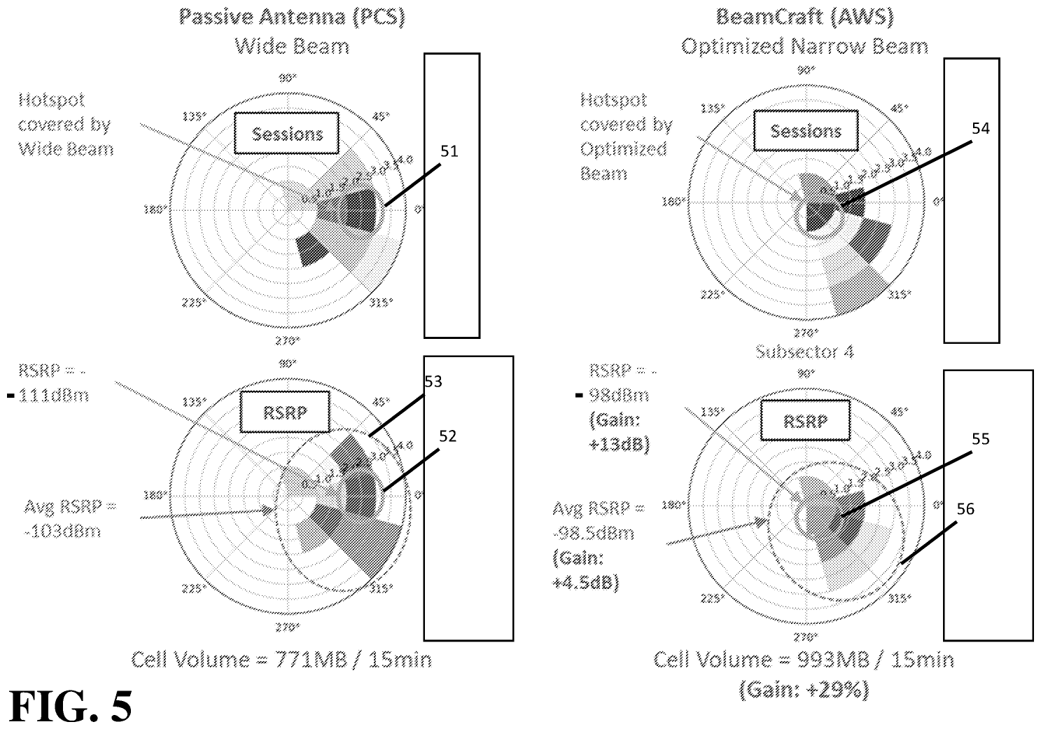

FIG. 5 shows the session counts at the locations around the cell site where the beamforming active antenna RU was deployed. The locations with large session counts may be considered traffic hotspots (see circled area 51) where a high density of active users is concentrated. By steering the RF beams onto those traffic hotspots, it is possible to increase the signal quality (e.g., Reference Signal Receive Power or RSRP) in locations where users were most concentrated Moreover, in an area where multiple adjacent beamforming active antenna RUs are deployed, one could further jointly optimize the beam steering angles to avoid pointing beams from different cells at the same locations to mitigate inter-cell interference in the cellular network.

Referring to FIG. 5, each angular bin (at a given distance from the antenna at a given azimuth angle) represents the measurement of interest at a certain geographic region. The leftmost column of sub-figures shows the Number of Sessions (top sub-figure) and Reference Signal Receive Power (RSPR) (bottom sub-figure) for a passive antenna. It can be seen that the passive antenna serves a wide area and does not target its RF energy towards the traffic hotspots (where the Number of Sessions is high), and correspondingly those traffic hotspots experience low RSRP receive power levels (see circled area 52). The RSRP is about −111 dbm within this area; furthermore, within the larger dashed area 53, the average RSRP is −103 dbm.

The beamforming antenna (BeamCraft) shown on the rightmost column of sub-figures optimizes its RF energy on the traffic hotspots 54 (top sub-figure), and those traffic hotspots observe higher RSRP 55 (bottom sub-figure). It can be seen that the beamforming antenna serves a narrower area and does target its RF energy towards the traffic hotspots (where the Number of Sessions is high), and correspondingly those traffic hotspots experience a 13 db RSRP receive power level gain over the passive antenna (see circled area 55). The RSRP is about −98 dbm within this area 55; furthermore, within the larger dashed area 56, the average RSRP is −98.5 dbm indicating a 4.5 db gain over the passive antenna result 53.

The user distribution in the cellular network is not static. FIG. 5 illustrates a case where there was a rally in the city, and there was a large crowd of users gathered outside a Convention Center in the downtown area. By steering the beams onto this region near the Convention Center, one observed that the beamforming active antenna RU is able to achieve 3X the spectral efficiency compared to a traditional passive antenna in the adjacent PCS band.

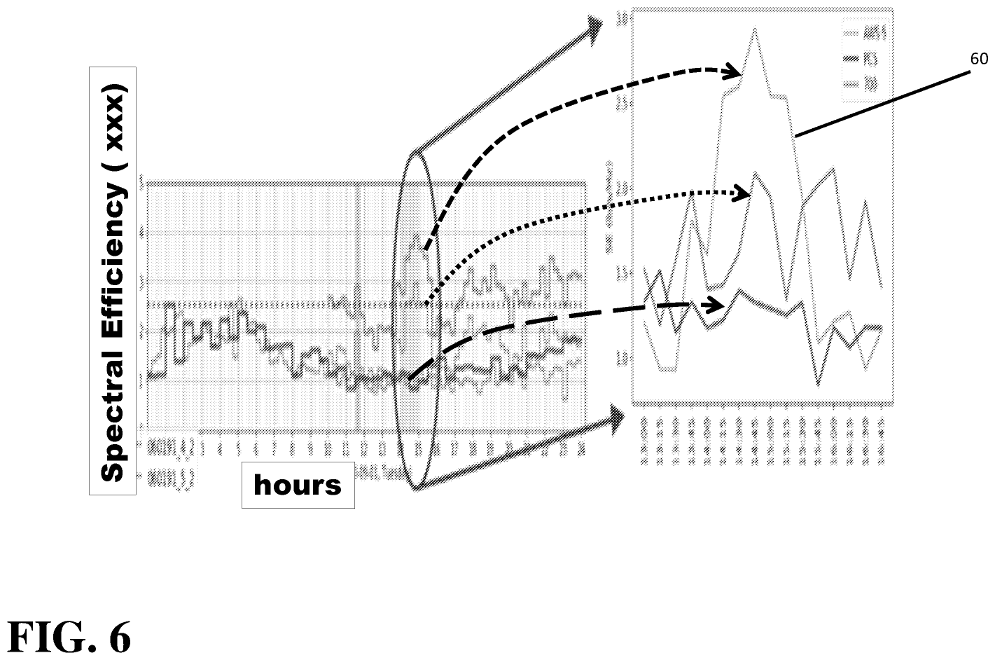

Referring to FIG. 6, the plot shows the spectral efficiency vs. time for different antennas for a given day. The inset figure zooms into the time period of interest: 1 pm-5 pm. The active antenna optimize its beam pattern to focus its RF energy on traffic hotspots that were formed at about 2:15 pm-3:15 pm, while the other passive antennas (not being able to adapt their RF beam patterns) have static RF patterns for the wide area without focusing on the traffic hotspots during. It is seen in the inset figure that by optimizing the beam patterns to target the traffic hotspots, the active antenna (medium dashed line 60) achieves about 3× the spectral efficiency compared to its spectral efficiency before 2 pm and after 4 pm. In contrast, the passive antennas (short and long dashed lines) do not experience a comparable surge in spectral efficiency.

At the second cell site where the beamforming active antenna RU was deployed, the antenna installation location was partially obstructed by a wing of a parking garage building. For the passive antennas installed at that location, since there was no adjustment possible in the azimuth direction, about half of the antenna radiation pattern was blocked by the garage building and resulted in poor signal quality for the cellular users attached to this cell. The beamforming active antenna RU at this site was able to steer the beams to avoid the garage building obstruction and set the beam width to a narrow beam to focus the RF energy to the region where the RF signal was not obstructed. The users located behind the garage building were able to be served by an adjacent cell with better signal quality.

Other embodiments are within the claims below.

What is claimed is:

1. A method of operating a phased array communication system for communicating with a plurality of user equipment (UEs), said method comprising the steps of:
defining a first set of communication beams and a second set of communication beams, wherein said first set of communications beams includes one or more differently directed and/or shaped first beams and said second set of communications beams includes one or more differently directed and/or shaped second beams that are different from said first beams;
executing a cycle of operation multiple times, said cycle of operation involving a first phase followed by a second phase, wherein said first phase involves activating said first set of communication beams for a first period of time; and while activating said first set of communication beams, obtaining a plurality of performance measurements for each communication beam of said first set of communication beams, and wherein said second phase involves activating said second set of communication beams for a second period of time; and while activating said second set of communication beams, obtaining a plurality of performance measurements for each communication beam of said second set of communication beams;
executing said cycle of operation multiple times, performing a statistical analysis of said performance measurements obtained for said beams of said first and second set of communication beams;
identifying which said set of communication beams yields a best communications performance; and
using said set of communication beams with said best communications performance to communicate with said UEs.

2. The method of claim 1, further comprising the steps of:
maintaining a communication link with said plurality of UEs during all said cycles of operation.

3. The method of claim 1, wherein
historical long-term data is used to select said first set and said second set of communications beams, said historical long-term data is comprised of weekly and daily patterns of user distribution and activity levels.

4. The method of claim 1, wherein
said best beam pattern is selected from said sets of beam candidates by using:
a tournament pairwise comparison to advance said best beam pattern;
a round-robin manner to identify said best beam pattern; or
an analysis of variance to identify said best beam pattern out of three or more sets of communication beams.

5. The method of claim 1, wherein
said performance measurements comprises one or more performance data, said performance data is comprised of channel quality, volume (amount of data traffic), number of users, spectral efficiency, session count, resource block utilization, throughput, receive power, and signal quality.

6. The method of claim 1, wherein
said first period of time and said second period of time are equal in duration.

7. The method of claim 1, wherein
said first period of time and said second period of time have different durations.

8. The method of claim 1, further comprising the steps of:
controlling said beams in terms of an interface, said phased array communication system featuring an open interface according to the Open Radio Access Network (O-RAN) Management Plane (M-Plane) beamforming specifications.

9. A method of operating a phased array in a communication system, at a given location, to communicate with a plurality of mobile stations, said method of comprising the steps of:
selecting a time slot of a day-of-week and of a time-of-day;
partitioning said time slot in a plurality of sub-time slots;
selecting, for said given location, a set of beam candidates based on a historical long-term data and user information stored in data storage for each said plurality of sub-time slots within said time slot;
cycling through said sub-time slots with its corresponding said set of beam candidates formed by said phased array, wherein each set of sub-time slots is repeated a plurality of times, each repeat forming a single cycle of operation;
acquiring and storing received performance data of each sub-time transmitting said set of beam candidates during each of its corresponding sub-time slots of said plurality of sub-time slots repeated said plurality of times;
statistically testing said received performance data to find, for each said plurality of sub-time slots, a best beam pattern out of said set of beam pattern candidates, said selecting based on said received performance data said best beam pattern that yields a best communications performance; and
using said best beam pattern for each said plurality of sub-time slots to communicate with said mobile stations.

10. The method of claim 9, further comprising the steps of:
configuring said phased array to produce said best beam pattern.

11. The method of claim 9, further comprising the steps of:
maintaining a communication link with said plurality of UE during all said cycles of operation.

12. The method of claim 9, wherein
time to complete all cycle of operations ranges between a period of an hour to a fraction of a minute.

13. The method of claim 9, wherein
said time slot uses historical long-term data to select said set of beam candidates,
said historical long-term data is comprised of weekly and daily patterns of user distribution and activity levels.

14. The method of claim 9, wherein
said best beam pattern is selected from said sets of beam candidates by using:
a tournament pairwise comparison to advance said best beam pattern;
a round-robin manner to identify said best beam pattern; or
an analysis of variance to identify said best beam pattern out of three or more sets of communication beams.

15. The method of claim 9, wherein
said testing utilizes a t-test to select one of two sets of communication beams.

16. A beamforming active antenna radio unit, within a communication system, in a given location, to communicate with a plurality of mobile stations, comprising:
a plurality of antenna elements configured to support a plurality of transmit and receive beams to said plurality of mobile stations;
a list of beam candidates is identified based on information comprising previous time periods at a same day-of-week and a same time-of-day;
each beam candidate is based on said list of beam candidates and said plurality of antenna elements are configured using data from each said beam candidate;
said plurality of antenna elements are configured to each of said beam candidate within said list of beam candidates at least once during a first cycle of operation, wherein performance data for two or more cycles are gathered;
a statistical performance testing framework using said performance data to narrow said list of beam candidates down to said best beams out of said list of beam candidates; and
said best beams selected to communicate to said mobile stations added to said list of beam candidates within a data storage stored under same said day-of-week and same said time-of-day.

17. The apparatus of claim 16, wherein
said information further comprises historical long-term environment, said location, historical user data, and historical network data.

18. The apparatus of claim 16, wherein
each said beam candidate comprises a beam steering angle, its beam width, any required tapering, a transmission power of a main lobe, and a proper placement of nulls.

19. The apparatus of claim 16, wherein
said best beam pattern is selected from said sets of beam candidates by using:
a tournament pairwise comparison to advance said best beam pattern;
a round-robin manner to identify said best beam pattern; or
an analysis of variance to identify said best beam pattern out of three or more sets of communication beams.

20. The apparatus of claim 16, wherein
duration of said cycle varies from a fraction of a minute to a period of an hour.
